(19) United States
(12) Patent Application Publication
(10) Pub. No.: US 2012/0028772 A1
(43) Pub. Date: Feb. 2, 2012

(54) ROLLER COMPRISING A DRIVE SHAFT AND A ROLLER RING, AS WELL AS A METHOD FOR ASSEMBLING SUCH A ROLLER

(75) Inventor: Milinko Prusic, Saltsjo-Boo (SE)

(73) Assignee: Sandvik Intellectual Property AB, Sandviken (SE)

(21) Appl. No.: 13/254,878

(22) PCT Filed: Feb. 19, 2010
(86) PCT No.: PCT/SE2010/050197

§ 371 Date: Oct. 18, 2011

(30) Foreign Application Priority Data
Mar. 12, 2009 (SE) 0900325-2

(51) Int. Cl. B21B 27/03; B23P 11/02

(52) U.S. Cl. 492/1; 29/895.212

(57) ABSTRACT

The invention relates to a roller of the type that comprises, on one hand, a drive shaft, which has a cylindrical envelope surface having a certain outer diameter and a certain length, and, on the other hand, a shorter roller ring, which includes an outer ring of a hard material and an inner ring concentric with the same and of a more ductile material, which includes a cylindrical inside having a certain inner diameter and is, on one hand, permanently united to the outer ring in a metallurgical way, and, on the other hand, rotationally rigidly connected with the drive shaft in order to, from the same, transfer torque to the outer ring. According to the invention, the rotationally rigid joint between the drive shaft and the roller ring solely consists of a shrink-fit joint that is established between the envelope surface of the drive shaft and the inside of the inner ring and has an interference of at least 0.01% of the outer diameter of the drive shaft.

### TECHNICAL FIELD OF THE INVENTION

In a first aspect, this invention relates to a roller of the type that comprises, on one hand, a drive shaft, which has a cylindrical envelope surface having a certain outer diameter and a certain length, and, on the other hand, a roller ring, which includes an outer ring of a hard material and an inner ring concentric with the same and of a more ductile material, which includes a cylindrical inside having a certain inner diameter, and is, on one hand, permanently united to the outer ring in a metallurgical way, and, on the other hand, rotationally rigidly connected with the drive shaft in order to transfer driving torque to the outer ring from the drive shaft.

In a further aspect, the invention also relates to a method for assembling such a roller.

Rollers of the type generally mentioned above are denominated combi rollers by those skilled in the art and are used in practice for hot or cold rolling of long narrow products of metal, such as wires, bars, tubes, etc. For this purpose, the roller rings are formed with one or more circumferential grooves, which form the product in the desired sequence. The roller rings may also be entirely smooth when they have the purpose of rolling flat objects, such as strips. In some rollers, the roller rings consist of so-called composite roller rings of the type that is manufactured from an inner ring of an iron-based casting alloy, e.g., nodular iron, and one or more outer rings embedded in the same and formed of a hard, wear-resistent and heat-resistant material, such as cemented carbide, which are permanently united to the inner ring in a metallurgical way, more precisely by embedding the outer rings in the alloy during the casting.

The use of roller rings of cemented carbide in rollers of the kind in question has a developmental history of many years, all the way from simple roller constructions in which it was tried to connect a cemented carbide ring directly with the drive shaft merely in a Mechanical way (via wedges, lugs, bars or other drivers), up to today's constructions in which the individual cemented carbide ring usually is united metallurgically with an inner ring of a more ductile material, which in turn can be connected to the drive shaft without annoying stress phenomena arising in the cemented carbide ring. In recent years, the development has been focused on two principal problem areas, viz. in the first place the selection of materials of the roller ring, and then, in particular, the selection of suitable materials of its inner ring, and in the second place the problem of reliably securing the roller ring rotationally in relation to the drive shaft. Among other things (see EP 0374116), for the material of the inner ring, the material development has resulted in the use of a magnesious nodular iron, including dispersed, spheroidal graphite, which by heat treatment can be freed from a suitable amount of residual austenite under conversion into, for instance, bainite. The experiments for solving the second problem, viz. to be able to transfer great torques from the drive shaft to the roller ring without the same slipping in relation to each other, have resulted in a large number of proposals of solutions that are well documented in the patent literature (in addition to the above-mentioned EP 0374116, see also U.S. Pat. No. 5,558,610, U.S. Pat. No. 5,735,788, U.S. Pat. No. 6,685,611, as well as EP 1733816). However, common to hitherto known solutions is still that the torque from the drive shaft to the roller ring is effected via mechanical lock means, which in one way or another act between the drive shaft and the inner ring of the roller ring. One category of lock means consists of male and female elements that engage each other and are located either in the interface between the inside of the inner ring and the envelope surface of the drive shaft, or in end surfaces of the roller ring and a number of rings co-operating with the same on the outside of the drive shaft pressed against each other (see in both cases EP 0374116). Another category of lock means relies on friction joints between co-operating surfaces. Also in this case, the joints may be located either in the interface between the inside of the inner ring and the envelope surface of the drive shaft or in the ring-shaped end surfaces of rings that co-operate with the roller rings. In order to realize such friction joints, wedges, lock nuts, hydraulic devices, etc., can be used.

However, a disadvantage of also the simplest lock means of a mechanical nature is that the same require some form of cutting or chip removing machining in addition to the compulsory turning, viz. milling, drilling, thread-forming, etc. Each such, additional machining operation makes the manufacture more expensive not only as a consequence of the fact that the individual working operation is time-consuming, but maybe above all as a consequence of the fact that the pieces have to be moved between different machining stations, with the ensuing set-up times. Another disadvantage of the mechanical lock means is that the same impair the capacity of the roller, which is determined by how many roller rings (or grooves in the same) that can be mounted within the given roller width such as this is determined by the effective length of the drive shaft. If the lock means intrude on the roller width, of course the number of effective roller grooves is reduced. At times, the lock means may also give rise to detrimental stress phenomena in the roller ring. In addition, in particular female-like recesses in the respective components may weaken the roller construction in its entirety.

### OBJECTS AND FEATURES OF THE INVENTION

The present invention aims at obviating the above-mentioned disadvantages of previously known rollers and at providing an improved roller. A primary object of the invention is therefore to provide a roller, the roller ring of which can be secured rotationally in a reliable way in relation to the drive shaft without any mechanical lock means of the traditional kind. An additional purpose is to provide a roller having an optimum capacity in respect of the number of roller rings and/or roller grooves along the length extension of the drive shaft. Yet an object of the invention is to provide a roller, the two main components of which, i.e., the drive shaft and the roller ring or rings, can be manufactured by an absolute minimum of machining operations.

According to the invention, at least the primary object is achieved by the features defined in the characterizing clause of claim 1. Preferred embodiments of the roller according to the invention are furthermore defined in the dependent claims 2-4.

In a further aspect, the invention also relates to a method for putting together a roller according to the invention. The features of this method are seen in the independent claim 5.

### SUMMARY OF THE INVENTION

The invention is based on the surprising understanding that a sufficiently strong shrink-fit joint, which can be realized by means of accurate stress calculations and a well-balanced dimensioning of the roller ring in relation to the drive shaft, is fully sufficient to rotationally secure the first-mentioned one in relation to the last-mentioned one. By having a shrink-fit joint with an interference or shrink fit of at least 0.01% of the diameter of the drive shaft in question, it has accordingly turned out that the roller ring can be subjected to fully satisfactory torques without slipping on the drive shaft in spite of the fact that all types of mechanical lock means between the two components are eliminated. Directly contrary to the traditional design philosophy, the roller according to the invention can therefore be manufactured without any additional details whatever than the two vital main components, viz a drive shaft and a roller ring (or several).

### BRIEF DESCRIPTION OF THE APPENDED DRAWINGS

In the drawings:

FIG. 1 is a sectioned perspective view of a roller according to the invention in an assembled state,

FIG. 2 is a longitudinal section through the same roller in the same state,

FIG. 3 is a longitudinal section through solely a roller ring included in the roller,

FIG. 4 is a longitudinal view of solely the drive shaft of the roller,

FIG. 5 is a cross section V-V in FIG. 3,

FIG. 6 is a cross section VI-VI in FIG. 4, and

FIG. 7 is a detailed enlargement VII in FIG. 3.

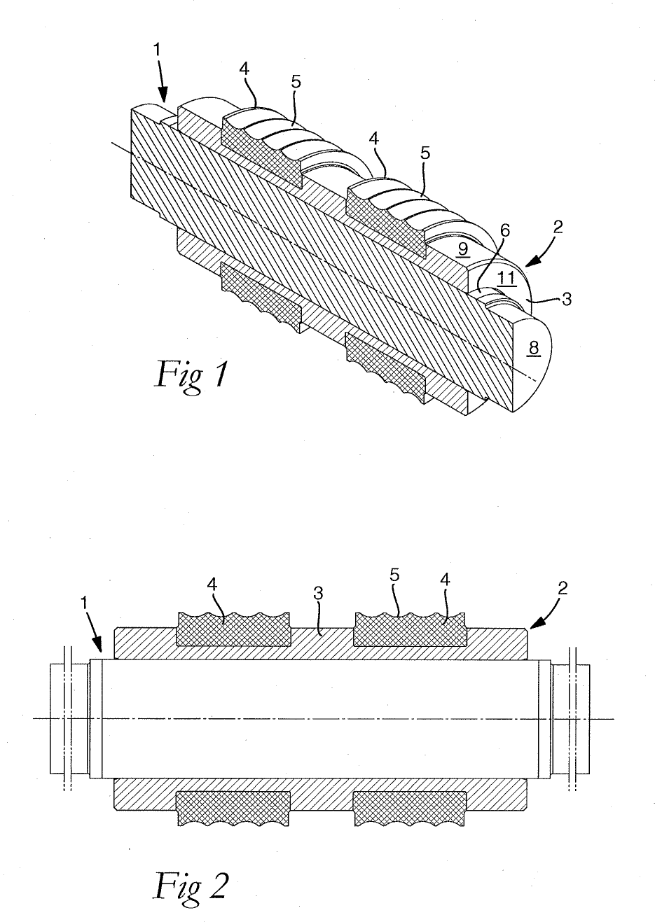

### DETAILED DESCRIPTION OF A PREFERRED EMBODIMENT OF THE INVENTION

In the drawings, 1 generally designates a roller or drive shaft, and 2 a roller ring mounted on the outside of the same. In the example, said roller ring 2 comprises an inner ring 3 as well as two outer rings 4 in the envelope surfaces of which circumferential roller grooves 5 for rolling of long narrow products are formed.

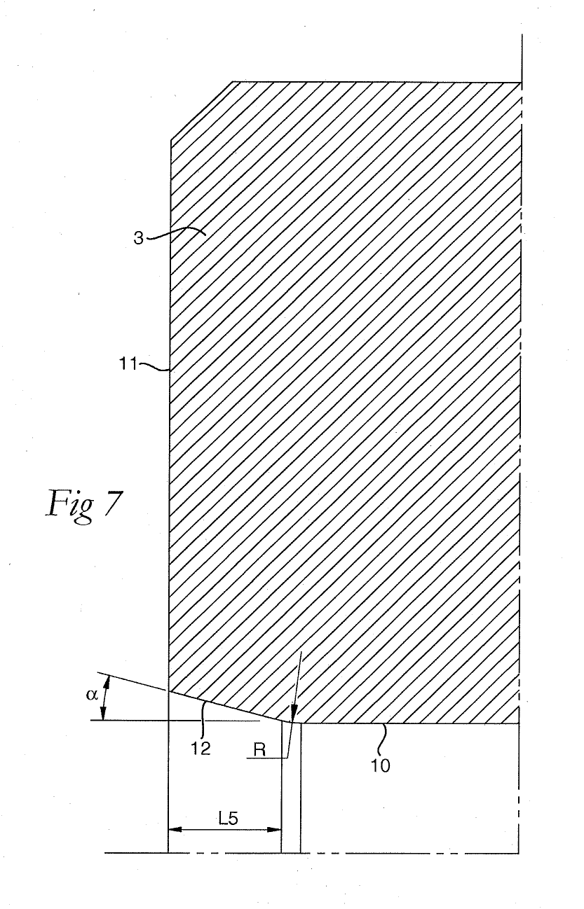

The drive shaft 1 includes a roll barrel in the form of a cylindrical envelope surface 6 (see FIG. 4), which is concentric with a centre axis C1 of the shaft, and which at opposite ends transforms into envelope surfaces of shaft journals 7 having a reduced diameter. The two ends of the shaft consist, in this case, of plane end surfaces 8 of the two shaft journals 7. The total length L1 of the shaft is determined by the distance between the two end surfaces 8. Since each shaft journal 7 has a certain length L2, the axial extension or length L3 of the envelope surface 6 is smaller than the total length L1 of the shaft. The outer diameter of the shaft along the envelope surface 6 is designated OD1 (see FIG. 6).

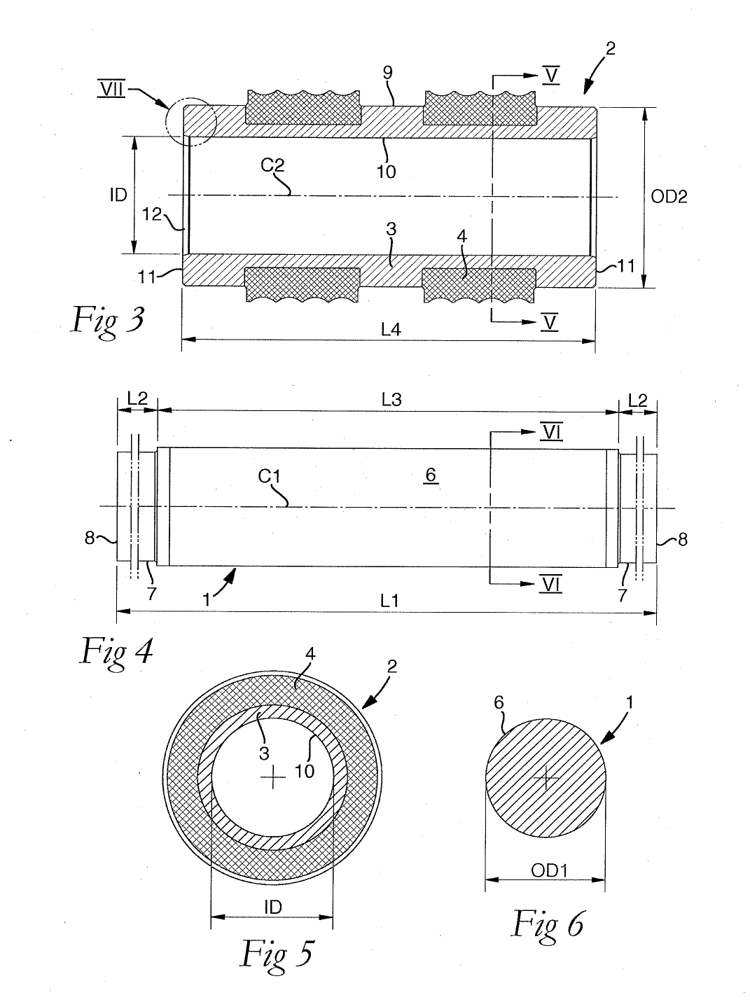

The inner ring 3 of the roller ring 2 (see FIG. 3) includes an envelope surface 9 and an internal surface or inside 10, which both have a cylindrical basic shape and are concentric with the centre axis C2 of the roller ring. The two opposite ends of the inner ring consist of ring-shaped, plane surfaces 11, the distance of which from each other determines the axial length L4 of the inner ring. In FIGS. 3 and 5, ID designates the inner diameter of the inner ring 3, while OD2 designates the outer diameter thereof. Each one of the two outer rings 4 is cast-in in the envelope surface of the inner ring 3 and in such a way permanently united to the inner ring in a metallurgical way. The outer diameter (lacks reference designation) of the individual outer ring 4 is in this case greater than the outer diameter OD2 of the inner ring (they may also be equally large), while the inside of the outer ring has a diameter that, on one hand, is smaller than the outer diameter of the inner ring, but, on the other hand, greater than the inner diameter ID. It should also be mentioned that the centre axis C2 of the roller ring 2 coincides with the centre axis C1 of the drive shaft 1, when the roller has been assembled.

In practice, it is preferred to manufacture the drive shaft 1 from steel, although other materials are feasible too, in particular cast iron having a comparatively high hardness (high content of carbon). As a material of the outer rings 4 of the roller ring 2, advantageously traditional cemented carbide is used, i.e., a powder metallurgical material, which is obtained by pressing and sintering of a cemented carbide powder containing WC and a binder phase, e.g., Co, or Co+Ni+Cr. However, it should be pointed out that also other hard materials than traditional cemented carbide can be used, e.g., high speed steel. Finally, the material of the inner ring 3 generally consists of a material that is more ductile than the hard material of the outer ring, such as, for instance, a metal or a metal alloy. In most cases, here nodular iron is preferred, e.g., of the type that is disclosed in EP 0753594.

The manufacture of the two main components of the roller is effected in separate operations. The drive shaft 1 is manufactured from a cylindrical blank by external longitudinal turning of the envelope surface 6 and the outsides of the journals 7, as well as face turning of the end surfaces 8. The roller ring 2 is produced by casting of a blank in which pre-formed cemented carbide rings are embedded into liquid nodular iron that should form the inner ring. This blank is machined by turning, viz. external longitudinal turning of the envelope surface 9, internal longitudinal turning of the inside 10 as well as face turning of the end surfaces 11. Possibly, the internal surface 10 of the roller ring as well as the envelope surface 6 of the drive shaft may be honed in order to provide a good dimensional accuracy.

In a prototype embodiment, the envelope surface 6 of the drive shaft 1 has a length L3 of 756 mm and a diameter OD1 that in room temperature amounts to 200 mm. The measure L3 represents the maximum roller width. In this case, the length L4 of the roller ring 2 is smaller than the roller width and amounts to 700 mm. In room temperature, the roller ring has an inner diameter that is smaller than the diameter OD1 of the drive shaft and amounts, in the prototype embodiment, to 199.84 mm. This means that the difference between ID and OD1 amounts to 0.16 mm or 0.08% of the outer diameter OD1 of the drive shaft.

Assembling of the components 1 and 2 is effected by shrinking-on the roller ring onto the drive shaft. This can be made in various ways, one of which is to cool down the drive shaft 1 and maintain room temperature of the roller ring 2. If the drive shaft, in its prototype embodiment, is cooled down to −170° C. (e.g., in liquid nitrogen), the outer diameter OD1 of the envelope surface 6 is reduced from 200 mm to 199.55 mm. In this state, OD1 accordingly becomes 0.29 mm smaller than ID. In such a way, the drive shaft can be inserted into the interior of the roller ring. After positioning of the two components in the desired location in relation to each other, the temperature in the two components is equalized to room temperature. In this connection, the drive shaft expands and provides a shrink-fit joint, the interference of which amounts to 0.16 mm. Tests carried out have shown that a shrink-fit joint of this strength is fully sufficient to transfer considerable torques from the drive shaft to the roller ring without the last-mentioned one slipping in relation to the drive shaft (also when the roller operates under severe outer conditions, such as heavy load and frequent temperature fluctuations).

In order to facilitate the insertion of the drive shaft 1 into the roller ring 2 during the shrinking-on procedure, adjacent to the individual end surface 11 of the inner ring 3 of the roller ring (see FIG. 7), a conical surface 12 is formed, which transforms into the internal cylinder surface 10 of the inner ring via a radius transition R. In the example, the cone angle α of said surface 12 amounts to 15° (2×α=30°), the surface having an axial extension or length L5 that should amount to at least 5 mm, suitably at least 10 mm. It is also feasible to combine the female-like cone surface 12 in the roller ring with a male-shaped cone surface adjacent to the envelope surface 6 of the drive shaft.

In the above-mentioned, concrete example, the interference of the accomplished shrink-fit joint amounts to 0.08% of the diameter (0.16/200) of the drive shaft. The size of this interference may vary depending on the dimensions of the roller and desired torques, but should, however, at all events amount to at least 0.01%, suitably 0.05%, more suitably 0.07%. On the other hand, the same should not be more than 0.12% in order to reliably avoid the risk of detrimental stress phenomena in the roller ring. Advantageously, the joint is given an interference within the range of 0.07-0.10%.

### Advantages of the Invention

A substantial advantage of the invention is that the composite roller ring of the present roller can be rotationally secured to the drive shaft in a reliable and easy way without any mechanical lock or coupling means whatever. Furthermore, the effective roller width can be utilized in an optimal way because no coupling means whatever intrude on the available space along the envelope surface of the drive shaft. Furthermore, the two main components of the roller may be manufactured without complicated and cost-rising machining operations because essentially all the required chip removing machining can be made in the form of turning. In other words, the two component blanks do not need to be moved between different machining stations. The lack of mechanical coupling means, in particular female-shaped means in the form of grooves, holes, countersinks and the like, furthermore entails that no one of the components are unnecessarily weakened. Together, these factors mean that the total cost of the manufacture of the roller can be reduced. Because the number of components of the roller has been reduced to an absolutely minimum, the risk of breakdowns, shutdowns, etc., when the roller mill is in operation is in addition counteracted.

### Feasible Modifications of the Invention

The invention is not limited only to the embodiment described above and shown in the drawings. Thus, it is feasible to equip the drive shaft with two or several roller rings, which individually may include one as well as several cemented carbide rings. Furthermore, the shrinking-on of the individual roller ring may be carried out in another way than by cooling of the drive shaft. Accordingly, the drive shaft may maintain room temperature at the same time as the roller ring is heated in order to widen the interior thereof. It is also feasible to combine cooling of the drive shaft with heating of the roller ring. In conclusion, it should be pointed out that, according to the invention, the mounting method can be applied not only in the production of new rollers, but also in connection with the restoration of used rollers. If one of the two components of the roller would be damaged or worn, accordingly the other component can be re-used after separation of the shrink-fit joint, more precisely by being fixedly shrunk to a new or restored component. Although it is preferred to provide a shrink-fit joint having a complete surface contact between the envelope surface of the drive shaft and the inside of the roller ring it is, if required, also feasible to be content with partial surface contact.

1. Roller comprising, on one hand, a drive shaft, which has a cylindrical envelope surface having a certain outer diameter and a certain length, and, on the other hand, a shorter roller ring, which includes an outer ring of a hard material and an inner ring concentric with the same and of a more ductile material, which includes a cylindrical inside having a certain inner diameter and is, on one hand, permanently united to the outer ring in a metallurgical way, and, on the other hand, rotationally rigidly connected with the drive shaft in order to transfer torque to the outer ring from the drive shaft, wherein the rotationally rigid joint between the drive shaft and the roller ring solely consists of a shrink-fit joint that is established between the envelope surface of the drive shaft and the inside of the inner ring and has an interference of at least 0.01% of the outer diameter of the drive shaft.

2. Roller according to claim 1, wherein the interference of the shrink-fit joint amounts to at least 0.05% of the outer diameter of the drive shaft.

3. Roller according to claim 1, wherein the interference of the shrink-fit joint amounts to at least 0.07% of the outer diameter of the drive shaft.

4. Roller according to claim 1, wherein, adjacent to an end surface of the inner ring of the roller ring, a conical surface is formed that transforms into the inside of the inner ring via a radius transition.

5. Method for assembling rollers of the type that comprises, on one hand, a drive shaft, which has a cylindrical envelope surface having a certain diameter and a certain length, and, on the other hand, a shorter roller ring, which includes an outer ring of a hard material and an inner ring concentric with the same and of a more ductile material, which includes a cylindrical inside having a certain diameter and is, on one hand, permanently united to the outer ring in a metallurgical way, and, on the other hand, rotationally rigidly connected with the drive shaft in order to transfer torque to the outer ring from the drive shaft, comprising the steps of differentiating the temperatures of the drive shaft and the roller ring, respectively, inserting the drive shaft into the roller ring, and equalizing the temperatures while establishing a shrink-fit joint that forms the sole rotationally rigid joint between the drive shaft and the roller ring and has an interference of at least 0.01% of the outer diameter of the drive shaft.
